(19) United States
(12) Patent Application Publication
(10) Pub. No.: US 2013/0028317 A1
(43) Pub. Date: Jan. 31, 2013

(54) INTRA-MODE SEARCH FOR VIDEO ENCODING

(71) Applicants: Denis Vassilevich Parfenov, Moscow (RU); Ivan Leonidovich Mazurenko, Khimki (RU); Aleksey Alexandrovich Letunovskiy, Tokarevka (RU); Pavel Aleksandrovich Aliseychik, Moscow (RU); Denis Vladimirovich Parkhomenko, Moscow (RU)

(72) Inventors: Denis Vassilevich Parfenov, Moscow (RU); Ivan Leonidovich Mazurenko, Khimki (RU); Aleksey Alexandrovich Letunovskiy, Tokarevka (RU); Pavel Aleksandrovich Aliseychik, Moscow (RU); Denis Vladimirovich Parkhomenko, Moscow (RU)

(73) Assignee: LSI CORPORATION, Milpitas, CA (US)

(21) Appl. No.: 13/370,670

(22) Filed: Feb. 10, 2012

(30) Foreign Application Priority Data
Jul. 28, 2011 (RU) 2011131824

(51) Int. Cl. H04N 7/32

(52) U.S. Cl. 375/240.12; 375/E07.243

(57) ABSTRACT

A search method for identifying an intra mode that can produce acceptable video-encoding quality for a pixel block while striking a proper balance between the quality and processor load. In a representative embodiment, the search method relies on a set of mode-selection rules for iteratively identifying candidate intra modes. Each identified candidate is evaluated based on a comparison of its sum of absolute differences (SAD) with the smallest SAD in the set of the previously identified candidates. The mode-selection rules use the comparison results as conditions that efficiently guide the search method toward an intra mode that is suitable for encoding the pixel block with acceptable video quality. On average, a representative embodiment of the search method disclosed herein is advantageously capable of finding a suitable intra mode in fewer iterations than a comparable prior-art search method.

### BACKGROUND

1. Field of the Invention

The present invention relates to video encoding and, more specifically but not exclusively, to intra-mode prediction in video encoding.

2. Description of the Related Art

This section introduces aspects that may help facilitate a better understanding of the invention(s). Accordingly, the statements of this section are to be read in this light and are not to be understood as admissions about what is in the prior art or what is not in the prior art.

The H.26x and MPEG-z families of standards (where x=1, 3, 4 and z=1, 2, 4) employ intra-mode prediction to compress video data based on spatial redundancy present in a given frame or picture. To achieve high coding efficiency, a video encoder typically performs an exhaustive full search, during which the encoder calculates the sum of absolute differences (SAD) for each intra mode and chooses a mode corresponding to the minimum SAD value as the best mode for a block of pixels. This search makes the intra-mode-prediction algorithmic module one of the dominant components of a video encoder in terms of computational complexity and processor load.

### SUMMARY

Problems in the prior art are addressed, in part, by providing a search method for identifying an intra mode that can produce acceptable video quality for a pixel block that is being encoded while striking a proper balance between the quality and processor load. In a representative embodiment, the search method relies on a set of mode-selection rules for iteratively identifying candidate intra modes. Each identified candidate is evaluated based on a comparison of its sum of absolute differences (SAD) with the smallest SAD in the set of the previously identified candidates. The mode-selection rules use the comparison results as conditions that efficiently guide the search method toward an intra mode that is suitable for encoding the pixel block with acceptable video quality. On average, a representative embodiment of the search method disclosed herein is advantageously capable of finding a suitable intra mode in fewer iterations than a comparable prior-art search method.

According to one embodiment, provided is a machine-implemented method for encoding a block of video data based on a set of intra modes. The method has the steps of generating an evaluation value for the block using each of a first subset of one or more of the intra modes; identifying in the first subset an intra mode having a best evaluation value so far; and generating an evaluation value for the block using a current intra mode that is selected from the set. The current intra mode is not in the first subset. In addition to the first subset and the current intra mode, the set further comprises two or more remaining intra modes. The method further has the steps of comparing the evaluation value corresponding to the current intra mode with the best evaluation value so far; and selecting a next intra mode based on said comparison. One of the two or more remaining intra modes is selected to be the next intra mode, if the evaluation value corresponding to the current intra mode is better than the best evaluation value so far. A different one of the two or more remaining intra modes is selected to be the next intra mode, if the evaluation value corresponding to the current intra mode is not better than the best evaluation value so far. The method further has the step of generating an evaluation value for the block using said next intra mode.

According to another embodiment, provided is a machine-implemented video-encoding method. The method has the step of, while a search-termination criterion for a pixel block is not triggered, iteratively probing different intra modes by: selecting, based on a set of mode-selection rules, a candidate intra mode from a basis set of intra modes; comparing a value of an evaluation criterion corresponding to the selected intra mode with a best value of the evaluation criterion, said best value being determined over a set consisting of the intra modes that have been selected so far during said iterative probing; and determining, based on said comparison, whether the selected intra mode represents a success or a failure, wherein the set of mode-selection rules comprises at least one rule that is conditioned on success or failure. The method further has the steps of, when the search-termination criterion is triggered, identifying an optimal intra mode within a set consisting of intra modes that have been selected while the search termination criterion was not yet triggered; and encoding the pixel block using said optimal intra mode.

According to yet another embodiment, provided is an apparatus comprising a video-encoder configured to: while a search-termination criterion for a pixel block is not triggered, iteratively probe different intra modes, wherein the video encoder selects a candidate intra mode from a basis set of intra modes based on a set of mode-selection rules; compares a value of an evaluation criterion corresponding to the selected intra mode with a best value of the evaluation criterion, said best value being determined over a set consisting of the intra modes that have been selected so far during said iterative probing; and determines, based on said comparison, whether the selected intra mode represents a success or a failure, wherein the set of mode-selection rules comprises at least one rule that is conditioned on success or failure. The video encoder is further configured to: when the search-termination criterion is triggered, identify an optimal intra mode within a set consisting of intra modes that have been selected and evaluated while the search termination criterion was not yet triggered; and encode the pixel block using said optimal intra mode.

### BRIEF DESCRIPTION OF THE DRAWINGS

Other aspects, features, and benefits of various embodiments of the invention will become more fully apparent, by way of example, from the following detailed description and the accompanying drawings, in which:

FIGS. 1A-1C illustrate a basis set of intra modes that can be used in a video encoder for intra-mode prediction of a 4×4 block of pixels according to one embodiment of the invention;

FIG. 2 graphically shows a full-circle representation of a set of intra modes according to one embodiment of the invention;

FIG. 3 shows a flowchart of a search method that can be used in a video encoder according to one embodiment of the invention;

FIGS. 4-23 graphically show representative mode-selection diagrams that can be used in the search method of FIG. 3 according to various embodiments of the invention; and

FIG. 24 shows a flowchart of a mode-selection method that can be used in the search method of FIG. 3 according to one embodiment of the invention.

### DETAILED DESCRIPTION

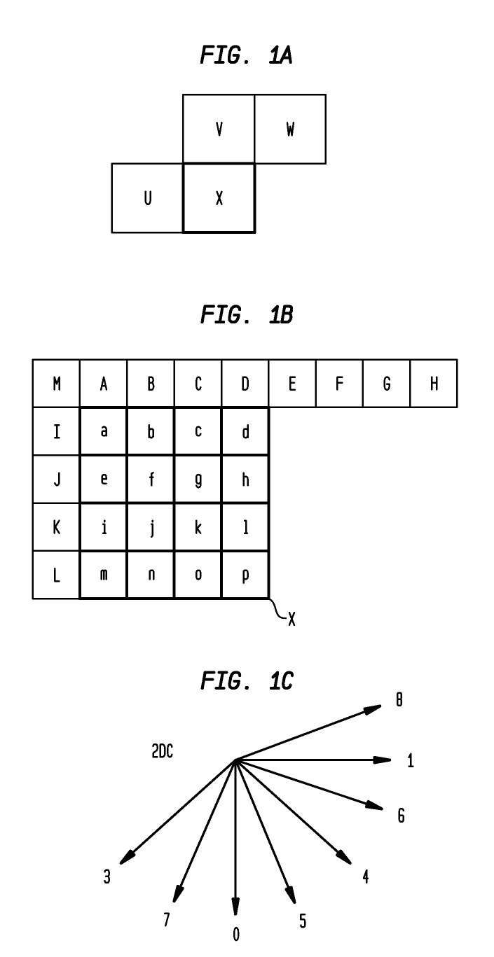

FIGS. 1A-1C illustrate a basis set of intra modes that can be used in a video encoder for intra-mode prediction of a 4×4 block X according to one embodiment of the invention. More specifically, FIG. 1A shows the positions of blocks U, V, and W with respect to block X, with blocks U, V, and W being the blocks that contain the pixels that can be used for intra-mode prediction of block X. FIG. 1B shows (1) the sixteen pixels of block X; (2) twelve relevant pixels of blocks U, V, and W, where pixels I,J,K,L⊂U, pixels A,B,C,D⊂V, and pixels E,F,G,H⊂W; and (3) the corner pixel M, where pixels A-M are the pixels that can be used in the intra-mode prediction of block X. FIG. 1C graphically shows directions corresponding to different intra modes of the basis set.

Intra-mode prediction exploits spatial correlation between adjacent pixel blocks of the same frame and is typically used for coding I-frames. Different intra modes selected for intra-mode-prediction coding typically correspond to different edge orientations for objects within the picture, with the direction of the intra mode selected for a particular block usually being the closest one to the orientation of an object edge within that block.

Referring now to FIGS. 1B-1C, mode 0 is the vertical intra mode in which (i) pixels a, e, i, and m of block X are predicted based on pixel A; (ii) pixels b, f, j, and n of block X are predicted based on pixel B, and so on.

Mode 1 is the horizontal intra mode in which (i) pixels a, b, c, and d of block X are predicted based on pixel I; (ii) pixels e, f, g, and h of block X are predicted based on pixel J, and so on.

Mode 2 is the DC intra mode in which all pixels (a to p) of block X are predicted by averaging the values of pixels A-D and I-L, e.g., as follows (A+B+C+D+I+J+K+L)/8.

For intra modes 3-8, the values for pixels a-p are predicted using a weighted combination of pixels A-M. For example, for mode 3, the value for pixel a is predicted as A/4+B/2+C/4; the value for pixels b and e is predicted as B/4+C/2+D/4; the value for pixels c, f, and i is predicted as C/4+D/2+E/4; and so on. The formulae for other intra modes can be found, e.g., in Draft ITU-T Recommendation and Final Draft International Standard of Joint Video Specification (ITU-T Rec. H.2641ISO/IEC 14496-10 AVC), which is incorporated herein by reference in its entirety.

As evident from FIG. 1C, every intra mode, except DC intra mode 2, corresponds to a vector, with the full set of these vectors occupying a semicircle. As further explained below, it is advantageous for various embodiments of the intra-prediction method disclosed herein to expand this semi-circle to a full circle. A full-circle representation of the intra modes is particularly helpful for the construction of various search trees and mode-selection diagrams that can be used by the video encoder in the process of identifying an acceptable intra mode for each given block of pixels.

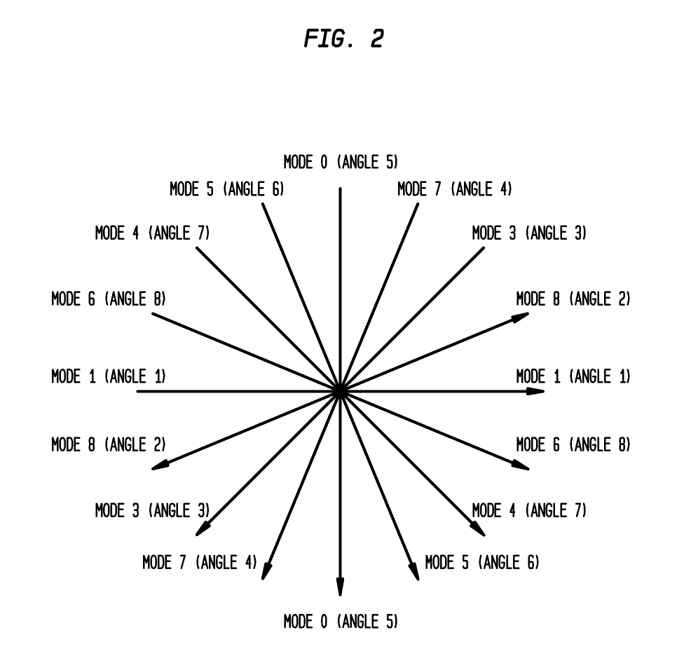

FIG. 2 graphically shows a full-circle representation of intra modes 0-1, 3-8 according to one embodiment of the invention. Geometrically, the full-circle representation of FIG. 2 can be derived from the semi-circle representation of FIG. 1C by extending each of the vectors corresponding to modes 0-1 and 3-8 past the point of origin. As a result, the previously empty semicircle is filled up, and transitions between any two modes can now be represented by two different rotation angles, one corresponding to a counterclockwise vector rotation and the other to the complementary clockwise vector rotation. For example, a transition from (vertical) intra mode 0 to (horizontal) intra mode 1 can be represented by either a 90-degree counterclockwise rotation or a 90-degree clockwise rotation. For comparison, in the semi-circle representation of FIG. 1C, the 90-degree clockwise rotation is undefined because it places the rotated “mode-0” vector into the empty semicircle.

Table 1 shows, in a tabular form, the full-circle representation of intra modes 0-1, 3-8 shown in FIG. 2. More specifically, Table 1 defines a one-to-one correspondence between intra modes 0-1, 3-8 and the integer-indexed angles labeled in FIG. 2. The mapping shown in Table 1 can also be viewed as an intra-mode renumbering scheme that helps to unveil certain useful properties of the intra-mode search space. These properties were previously cloaked by the historically settled intra-mode numeration, which appears arbitrary and irregular in the angular space. In contrast, the angle indices of Table 1 increment smoothly/consecutively in the angular space (also see FIG. 2). The latter property is beneficial, e.g., because mod(8) arithmetic can now be implemented for the set of intra modes in a relatively straightforward fashion.

TABLE 1
Mapping between Intra Modes and Vector Angles

| Angle Index | Intra Mode Number |
|---|---|
| 1 | 1 |
| 2 | 8 |
| 3 | 3 |
| 4 | 7 |
| 5 | 0 |
| 6 | 5 |
| 7 | 4 |
| 8 | 6 |

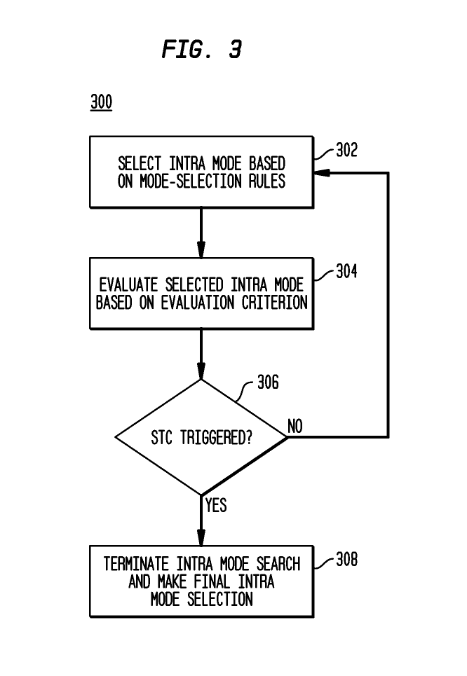

FIG. 3 shows a flowchart of an intra-mode-search method 300 that can be used in a video encoder according to one embodiment of the invention. Method 300 performs an intra-mode search in the cyclically closed angular space defined above in reference to FIG. 2 and/or Table 1 in a manner that enables the video encoder to find an acceptable intra mode for a given pixel block without performing an exhaustive intra-mode search and evaluation. As a result, the video encoder can advantageously produce relatively high video quality while devoting a relatively small share of its computational resources to intra-mode prediction.

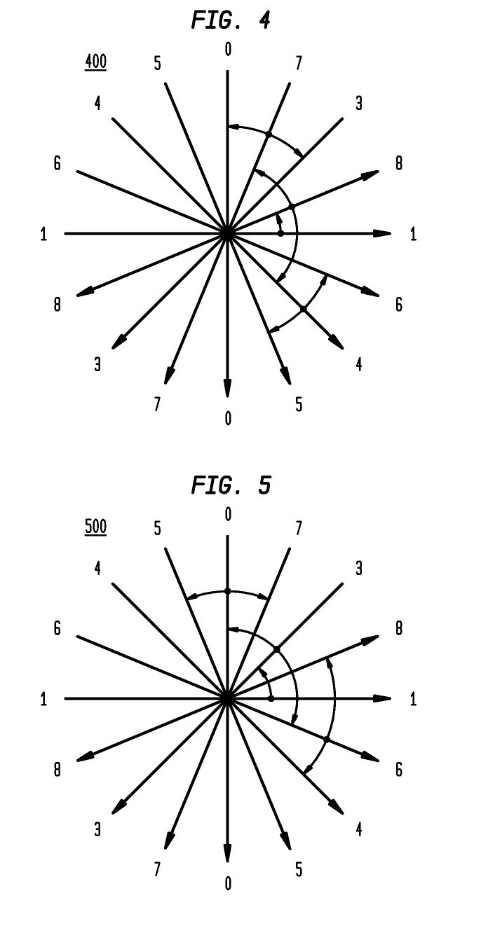

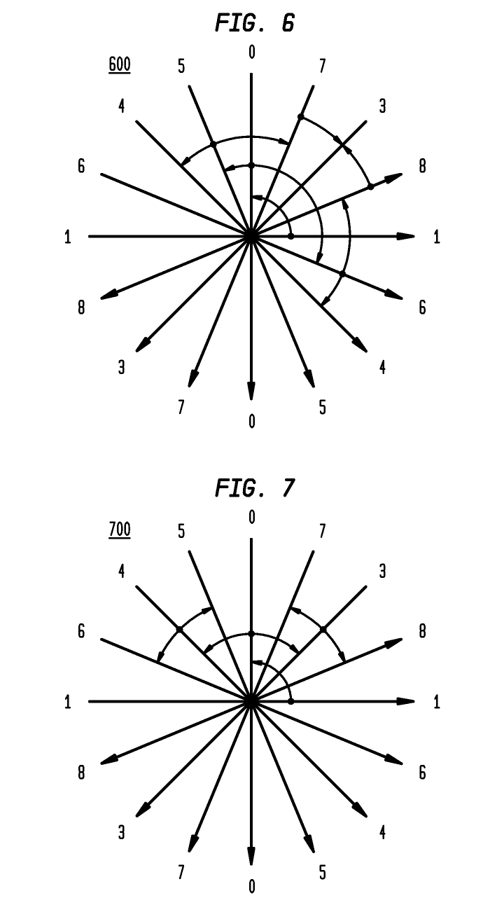

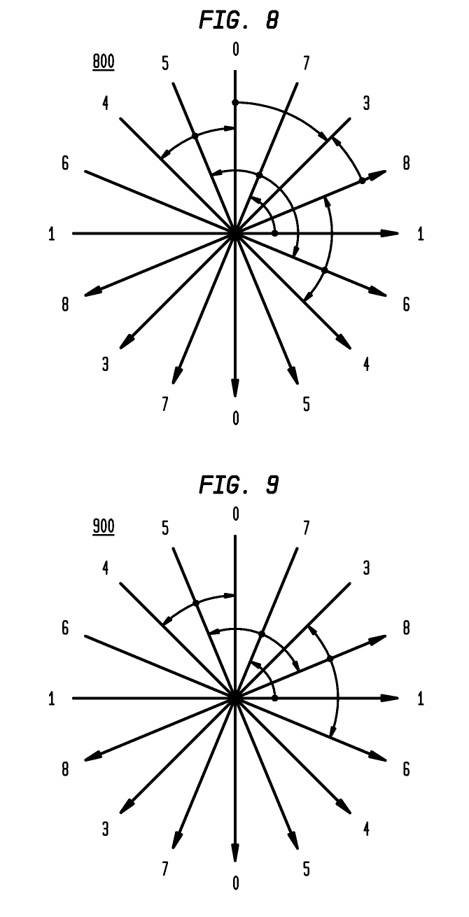

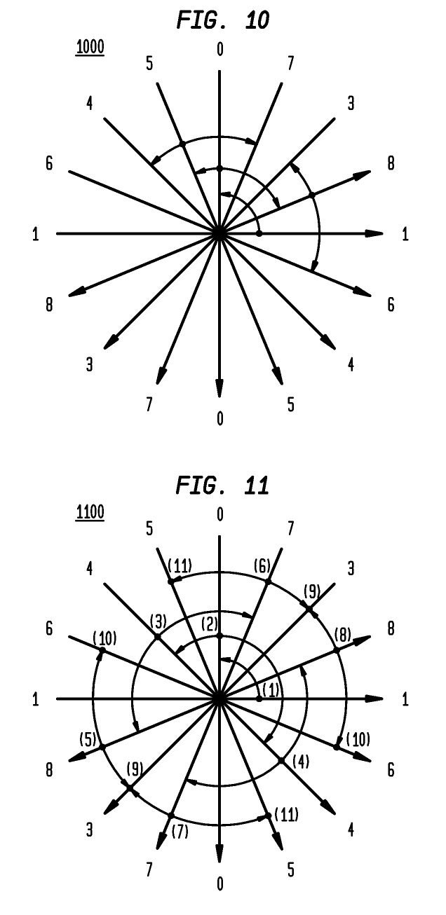

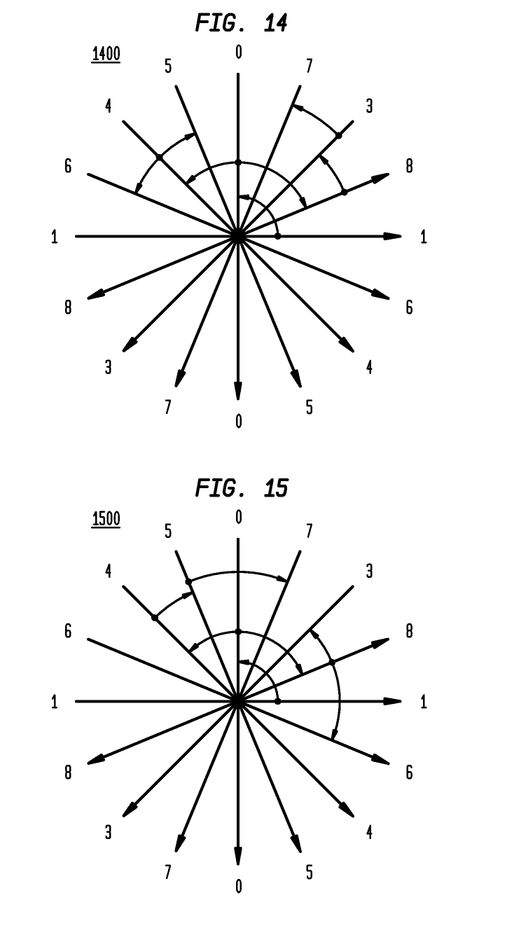

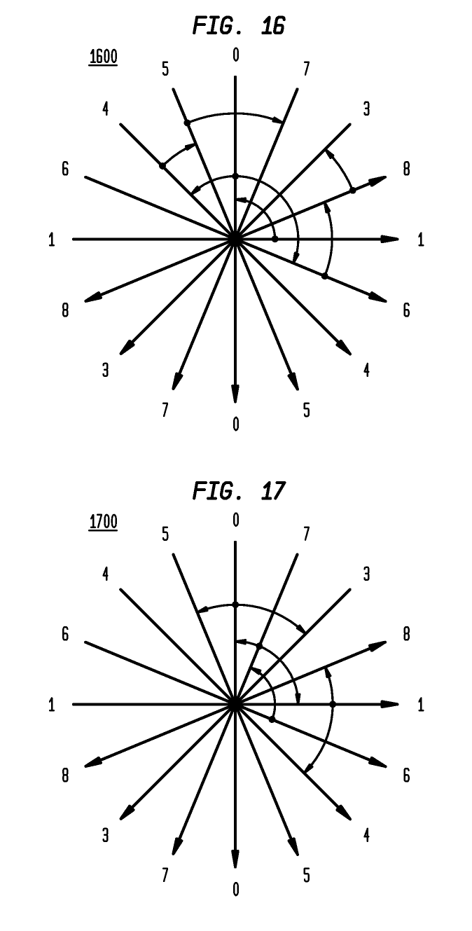

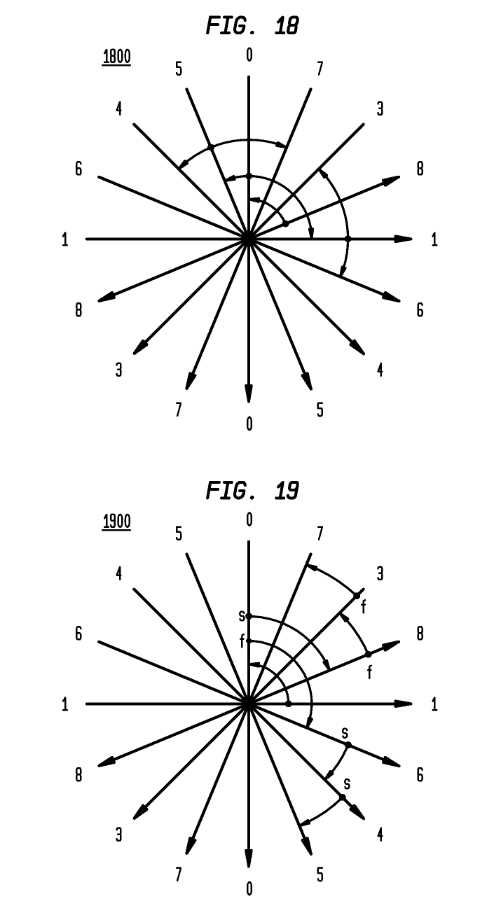

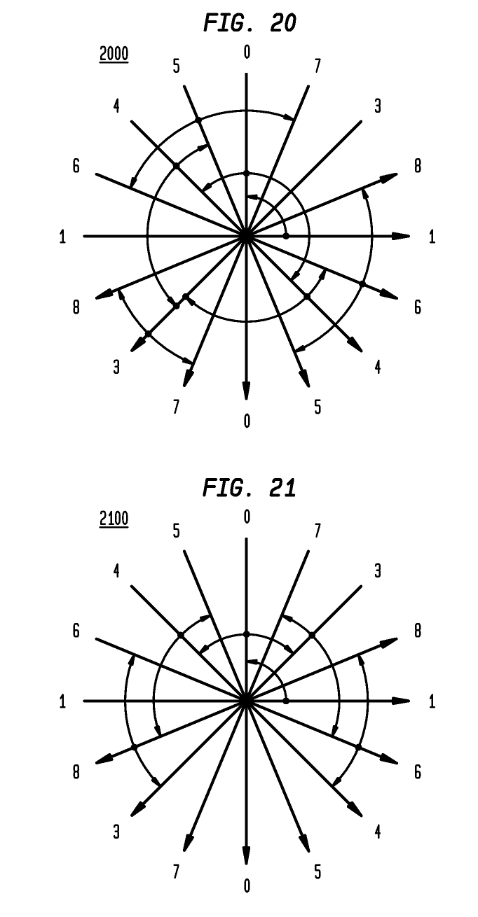

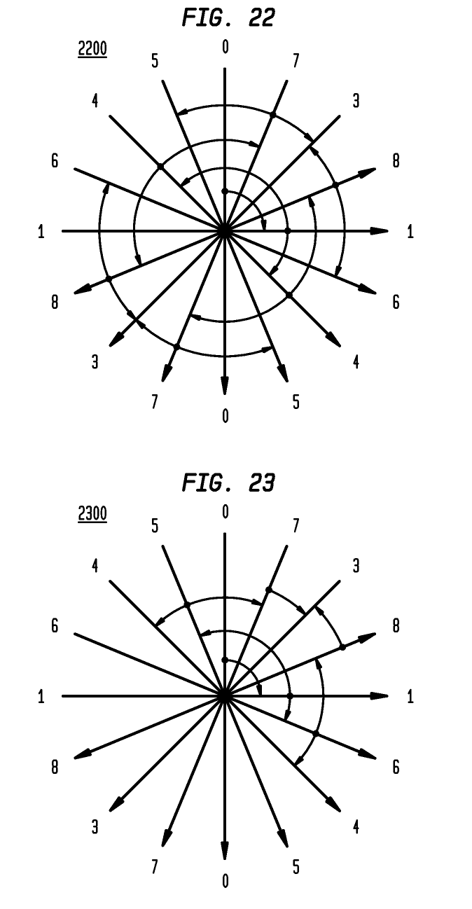

At step 302 of method 300, an intra mode to be evaluated is selected based on the acting set of mode-selection rules. In a typical embodiment, the acting set of mode-selection rules can be represented by a mode-selection diagram and a pointer to DC mode 2. Various mode-selection diagrams suitable for use in method 300 are described in more detail below in reference to FIGS. 4-23.

A single mode-selection diagram is typically used throughout the intra-mode search process for a given block, for all intra-predicted blocks within a video frame, and/or for all frames of a video sequence. Different mode-selection diagrams typically provide different video quality and also differ in the average amount of computational resources that the corresponding intra-mode search consumes. Also, for certain types of video sequences, some mode-selection diagrams may be more beneficial than others. Therefore, the selection and use of any particular mode-selection diagram in method 300 depends on the desired video quality, the amount of available computational resources, and/or the particular type of video sequence that is being handled by the video encoder.

The pointer to DC mode 2 can in principle be invoked at any time during the search process. However, it is usually beneficial to invoke this pointer at the very beginning of the search process, before the mode-selection diagram begins to be used. This benefit stems from the fact that, for most types of video sequences, DC mode 2 is the statistically most-prevalent intra mode. Therefore, there is a relatively high probability that DC mode 2 is the best intra mode for the pixel block in question and that further intra-mode search and evaluation will not be necessary.

At step 304, the intra mode selected at step 302 is evaluated based on a suitable evaluation criterion. In a representative embodiment, the evaluation criterion is a sum of absolute differences (SAD) between the actual pixel values and the predicted pixel values, the sum being taken over the pixel block in question. In alternative embodiments, other evaluation criteria (e.g., the peak signal-to-noise ratio, PSNR) may similarly be used.

At step 306, the evaluation criterion of step 304 is used to determine whether or not a search-termination criterion (STC) is triggered. If the STC is triggered, then the processing of method 300 is directed to step 308, where the intra-mode search is terminated and the final intra-mode selection is made for the pixel block. If the search-termination criterion is not triggered, then the processing of method 300 is directed back to step 302 for another iteration.

Eqs. (1)-(6) give several examples of search-termination criteria for various implementations of step 306:

$$\begin{matrix}{SAD}_{m} < α & ( 1 ) \\ n \geq {n}_{max} \geq 1 & ( 2 ) \\ \frac{{min}_{m ∈ s ( n )} ( {SAD}_{m} )}{{max}_{m ∈ s ( n )} ( {SAD}_{m} )} < β and n \geq 1 & ( 3 ) \\ \frac{{min}_{m ∈ s ( n )} ( {SAD}_{m} )}{n {max}_{m ∈ s ( n )} ( {SAD}_{m} )} < γ and n \geq 1 & ( 4 ) \\ \frac{{max}_{m ∈ s ( n )} ( {SAD}_{m} ) - {min}_{m ∈ s ( n )} ( {SAD}_{m} )}{n} < δ and n \geq 1 & ( 5 ) \\ \frac{{max}_{m ∈ s ( n )} ( {SAD}_{m} ) - {min}_{m ∈ s ( n )} ( {SAD}_{m} )}{n {max}_{m ∈ s ( n )} ( {SAD}_{m} )} < ɛ and n \geq 1 & ( 6 )\end{matrix}$$

where n is the number of times that step 302 has been performed for the current pixel block in; s(n) is the set of intra modes consisting of the intra modes that were selected for evaluation during those occurrences of step 302; m is the mode number (0≦m≦8); SADₘ is the SAD value corresponding to the m-th mode; and α, β, γ, δ, ε, and nₘₐₓ are threshold values corresponding to the different search-termination criteria. An additional STC is implicit to the search process of method 300: that is, the search process is automatically terminated when it has reached a terminal state of the corresponding mode-selection diagram (see FIGS. 4-23 and Table 2). In general, any one of the STCs can be used alone in step 306, or two or more STCs can be used together in step 306. For example, the STC expressed by Eq. (2) can be used together with an STC expressed by one of Eqs. (1) and (3)-(6), with the search termination occurring when either of the STCs is satisfied.

The mathematical construct that is being compared with the corresponding threshold value in each of Eqs. (1) and (3)-(6) can be viewed as a measure of video quality that is achievable with the set of intra modes that have been selected and evaluated so far during the iterative cycling of steps 302-306. Note that smaller values of this quality measure correspond to higher video quality.

In general, both the choice of the search-termination criteria for step 306 and the threshold value(s) used in those criteria affect the resulting encoded-video quality and the amount of computational resources that is being devoted by the video encoder to intra-mode-prediction coding. While the types of the search-termination criteria that are being used are usually fixed during the video processing corresponding to the entire given video sequence, the corresponding threshold value(s) need not be fixed. For example, a pertinent threshold value can be changed on the fly to reflect changes in the available processing power. The latter can fluctuate over time, e.g., depending on the number of parallel video streams that are being handled by the video encoder and/or the absence or presence of other tasks that are being executed by the host device/processor. By way of example, if the search-termination criterion expressed by Eq. (1) is being used at step 306, then threshold a can be (i) decreased when some additional processing power is freed up and (ii) increased when the host processor receives some additional task for execution.

The intra mode that is finally selected at step 308 to encode the pixel block is the intra mode that has the smallest SAD among the intra modes that have been probed. The finally selected intra mode may or may not be the same intra mode that would have been selected in the exhaustive search, during which each of the nine intra modes is evaluated. Method 300 is typically faster than the exhaustive search because one or more of the nine intra modes are left out without being evaluated.

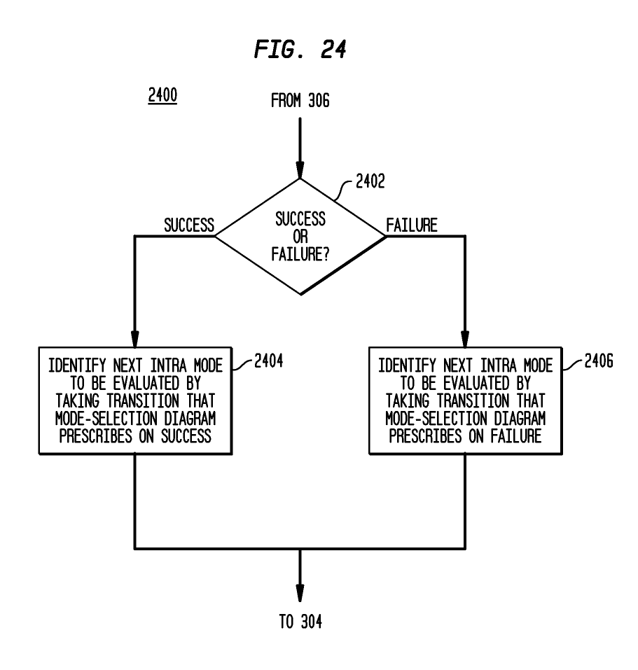

FIGS. 4-23 graphically show representative mode-selection diagrams 400-2300, each of which can be used at step 302 of method 300 according to various embodiments of the invention. Each of mode-selection diagrams 400-2300 is based on a full-circle representation of intra modes 0-1, 3-8 that is analogous to that shown in FIG. 2. The various arrows represent mode transitions that are used to identify and select the intra mode, which is then evaluated at step 304. Each mode transition has (i) the starting intra mode indicated by a dot and (ii) an ending intra mode located at the end of the corresponding arrow. Some mode transitions share the same starting intra mode, with a set of transition-selection rules being used to identify which transition is to be taken. These transition-selection rules are described in more detail below. A transition marked with an “s” is taken if the corresponding starting intra mode is deemed a “success.” A transition marked with an “f” is taken if the corresponding starting intra mode is deemed a “failure.” The definition of success and failure is given below in reference to FIG. 24. Note, however, that, for most transitions shown in FIGS. 4-23, the respective “f” or “s” is omitted because the description provided below makes such labeling unnecessary.

One skilled in the art will understand that each of mode-selection diagrams 400-2300 shown in FIGS. 4-23 can be converted, in a relatively straightforward manner, into a corresponding conventional decision-tree representation. More specifically, the entry point (intra mode) of the mode-selection diagram corresponds to the root of the decision tree. Two transitions that share the same starting intra mode represent different branches of the decision tree.

For each of mode-selection diagrams 400-2100, intra mode 1 is the entry point. For each of mode-selection diagrams 2200-2300, intra mode 0 is the entry point. In general, other mode-selection diagrams are conceivable in which an intra mode other than intra mode 0 or intra mode 1 serves as an entry point. The use of intra mode 0 or intra mode 1 as the entry point for mode-selection diagrams 400-2300 can be rationalized by the fact that, after DC mode 2, intra modes 1 and 0 are the next two most-often occurring intra modes for the overwhelming majority of video sequences. It is usually more advantageous to select and evaluate the more-probable intra modes earlier in the search process than the less-probable intra modes. The latter property of the search process justifies the use of intra mode 1 or intra mode 0 as an entry point for most of the mode-selection diagrams.

Mode-selection diagrams 400-2300 generally embody and/or rely on the following distinct principles:
A mode-selection diagram causes a single candidate intra mode to be selected for evaluation per iteration.
The sequence of mode transitions implemented in a mode-selection diagram merges a global-search strategy and a local-optimization strategy, without explicit switching between these strategies.

In contrast, prior-art search methods typically gravitate toward one of these strategies, with rather explicit switching between them. The global-search strategy enables method 300 to fill the angular search space with probes that are separated from one another by relatively large angular distances, thereby implementing elements of a global sparse search. The relatively large angular increments between the probes help to locate the general vicinity of the (yet unknown) optimal intra mode with relatively high speed. The local-optimization strategy takes into account and relies on the (typically) smooth dependence of the evaluation criterion (e.g., SAD) on the angle in the angular space, which enables efficient narrowing of the search space based on steep gradient-like descent. Both strategies are integrated into the mode-selection diagram to guide method 300 toward an “optimal” intra mode by trying to hit it in the very next iteration or, if unsuccessful, by predicting an advantageous candidate mode for the subsequent iteration.

As already indicated above, the more-probable intra modes tend to be evaluated earlier in the search process to reduce the total amount of iterations per pixel block. Therefore, mode-selection diagrams 400-2300 are constructed to be front loaded with more-probable intra modes. In the decision-tree representation of mode-selection diagrams 400-2300, the more-probable intra modes therefore appear relatively close to the root of the tree.

Mode-selection diagrams that are analogous to mode-selection diagrams 400-2300 can be constructed and used to find intra modes for any block size.

Mode-selection diagrams corresponding to both balanced and non-balanced decision trees can be used. A binary decision tree is called “balanced” when the path from its root (entry point) to the farthest leaf (end node) includes at most one more node than the path from the root to the nearest leaf. Therefore, the following misbalance measure (D) can be used to quantify the degree of misbalance for each decision tree:

D=L−S (7)

where L is the length of the longest path from the root to an end leaf, and S is the length of the shortest path from the root to an end leaf. For mode-selection diagrams 500, 600, 800, 1000, 1100, 1200, 1300, 1800, 1900, 2100, and 2300, the misbalance measure D=0. For mode-selection diagrams 700, 900, 2200, and 2400, the misbalance measure D=1. For mode-selection diagrams 1400, 1500, 1600, 1700, and 2000, the misbalance measure D=2.

FIG. 24 shows a flowchart of a mode-selection method 2400 that can be used to implement step 302 of method 300 (FIG. 3) according to one embodiment of the invention. Method 2400 can use any one of mode-selection diagrams 400-2300 and is operable while the search-termination criterion (STC) is not yet triggered (see step 306, FIG. 3). Method 2400 also relies on the results of the previously executed instances of step 304 (FIG. 3).

At step 2402 of method 2400, it is determined whether the previously selected intra-mode is a “success” or a “failure.” The intra mode is deemed to be a success if its evaluation criterion has the best value among those corresponding to all previously evaluated intra modes for this pixel block. For example, if the SAD is used as the evaluation criterion, then the intra mode is deemed to be a success when it has the smallest SAD among all previously evaluated intra modes. If the intra mode is not a “success,” then it is deemed to be a “failure.” On success, the processing of method 2400 is directed to step 2404. On failure, the processing of method 2400 is directed to step 2406.

For the entry point, the success or failure may be determined with respect to DC mode 2. If there is no reference value with respect to which the entry point can be evaluated (i.e., success or failure become undefined), then the entry point may have just one exit, which will be taken in the case of success, in the case of failure, and when the success and failure are undefined. For example, in mode-selection diagram 400, intra mode 1 (the entry point) has a single transition to intra mode 8. In each of mode-selection diagrams 500-1100, 1300-1600, and 1900-2300, the entry point has a similar property.

In some mode-selection diagrams, some intra modes that are not entry points also have a single exit. This exit is taken both in the case of success and in the case of failure. Examples of such intra modes can be found, e.g., in mode-selection diagrams 1300-1600.

At step 2404, the mode-selection diagram is used to identify the next intra mode to be evaluated by taking the transition that the mode-selection diagram prescribes on success. Most mode-selection diagrams are constructed so that, on success, the next intra mode to be evaluated is identified by incrementing the angle index corresponding to the current intra mode (see Table 1) by a relatively small integer and then applying mod(8) to the incremented angle index. The sign of the increment is typically chosen so that, in the angular space, the next intra mode is located, with respect to the current intra mode, in the same direction as the direction corresponding to the transition from the previous intra mode to the current intra mode. Each mode-selection diagram is constructed so that each intra mode is visited at most once, which means that the angular indices corresponding to the previously evaluated intra modes are effectively excluded from consideration.

At step 2406, the mode-selection diagram is used to identify the next intra mode to be evaluated by taking the transition that the mode-selection diagram prescribes on failure. Most mode-selection diagrams are constructed so that, on failure, the next intra mode to be evaluated is located in relatively close proximity to the previous intra mode in the direction that is opposite to the direction corresponding to the transition from the previous intra mode to the current intra mode.

For example, method 2400 may be implemented with mode-selection diagram 400 as follows.

The entry state is intra mode 1, which has a single exit to intra mode 8. Therefore, the second intra mode to be evaluated is intra mode 8 regardless of success or failure of intra mode 1 with respect to intra mode 2.

At the second instance of step 2402 (if it occurs), the SAD corresponding to intra mode 8 is compared with the SAD of intra mode 1 or 2 (whichever is smaller). If the SAD decreased, then step 2404 causes intra mode 7 to be selected. In the angular space, intra mode 7 is located relatively close to intra mode 8, and the corresponding transition is in the same direction as the transition from intra mode 1 to intra mode 8. If the SAD increased, then step 2406 causes intra mode 4 to be selected. In the angular space, intra mode 4 is located relatively close to intra mode 1, but in the opposite direction as the transition from intra mode 1 to intra mode 8.

At the third instance of step 2402 (if it occurs), the SAD corresponding to intra mode 7 or intra mode 4 is compared with the smallest SAD of the previously tested intra modes, which can be the SAD of intra mode 1, 2, or 8.

If the current intra mode is intra mode 7, then the SAD of intra mode 7 is compared with the SAD of intra mode 8. On success, the subsequent occurrence of step 2404 selects intra mode 0 (in the same direction as the transition from intra mode 8 to intra mode 7). On failure, the subsequent occurrence of step 2406 selects intra mode 3 (in the opposite direction as the transition from intra mode 8 to intra mode 7).

If the current intra mode is intra mode 4, then the SAD of intra mode 4 is compared with the SAD of the smaller of intra mode 1 or 2. On success, the subsequent occurrence of step 2404 selects intra mode 5 (in the same direction as the transition from intra mode 8 to intra mode 4). On failure, the subsequent occurrence of step 2406 selects intra mode 6 (in the opposite direction as the transition from intra mode 8 to intra mode 4).

Note that some mode-selection diagrams provide more than one angular-transition path to some intra modes. For example, mode-selection diagram 1100 (FIG. 11) provides the following two different angular-transition paths to intra mode 8. Path I: 1→0, then on failure 0→4, then on failure 4→8. Path II: 1→0, then on success 0→4, then on success 4→8. However, as already indicated above, regardless of the angular-transition path, no intra mode is visited twice.

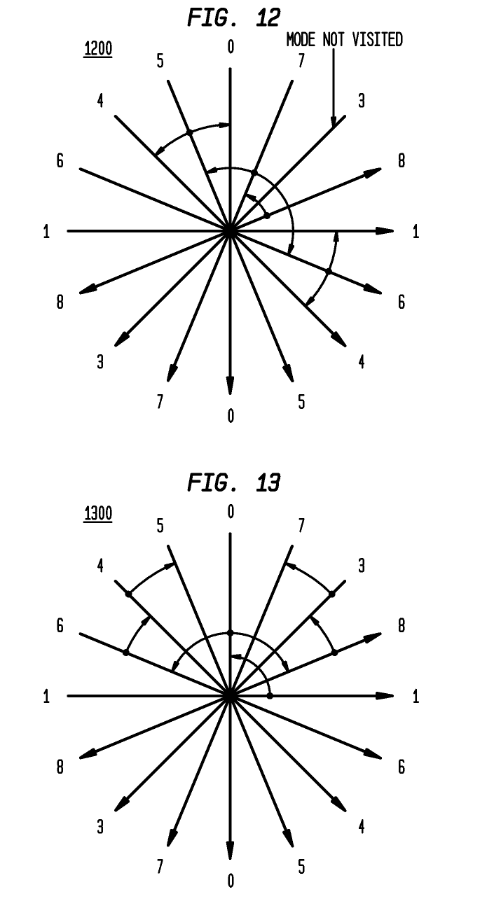

Further note that some mode-selection diagrams may contain no path to some intra modes. For example, mode-selection diagram 1200 (FIG. 12) contains no path to intra mode 3.

In one embodiment, a mode-selection diagram can be implemented as a look-up table that can be stored in the memory of the video encoder or be implemented in hardware, e.g., using programmable logic gate arrays. For example, Table 2 is a representative look-up table that can be used to implement mode-selection diagram 1100 (FIG. 11).

TABLE 2
Look-up Table Representing Mode-Selection Diagram 1100

| State | Angle | Intra Mode | New State on | New State on |
|---|---|---|---|---|
| Number | Index | Number | Success | Failure |
| 1 | 1 | 1 | 2 | 2 |
| 2 | 5 | 0 | 3 | 4 |
| 3 | 7 | 4 | 5 | 6 |
| 4 | 7 | 4 | 7 | 8 |
| 5 | 2 | 8 | 9 | 10 |
| 6 | 4 | 7 | 9 | 11 |
| 7 | 4 | 7 | 9 | 11 |
| 8 | 2 | 8 | 9 | 10 |
| 9 | 3 | 3 | 0 | 0 |
| 10 | 8 | 6 | 0 | 0 |
| 11 | 6 | 5 | 0 | 0 |

Referring to both FIG. 11 and Table 2, the states shown in the first column of Table 2 are indicated by dots in FIG. 11. The corresponding state numbers are shown in parentheses next to the dots. Each of states 9, 10, and 11 is a degenerate state because it includes two different angular locations that differ from one another by 180 degrees. Both of these angular locations correspond to the same angle index and the same intra mode. For example, state 9 is represented in FIG. 11 by two dots located at opposite sides of the line (vector) that represents angle index 3 and intra mode 3. Similarly, state 10 is represented in FIG. 11 by two dots located at opposite sides of the line that represents angle index 8 and intra mode 6. State 11 is represented in FIG. 11 by two dots located at opposite sides of the line that represents angle index 6 and intra mode 5. Some of the states shown in Table 2 correspond to the same intra mode (see, e.g., states 3 and 4, and also states 5 and 8). State 0 in Table 2 represents the end of the search. A simple inspection confirms that Table 2 implements the same mode transitions as mode-selection diagram 1100 and, as such, produces the same search results.

Based on FIG. 11 and Table 2, one of ordinary skill in the art will understand how to construct and use look-up tables representing other mode-selection diagrams.

Numerical simulations were carried out to determine a preferable mode for practicing method 300. For the video sequences that had been tested, the best results were obtained with mode-selection diagrams 1100, 600, and 2000.

As used herein, the term “block” refers to an image component used in video compression. A block comprises two or more pixels. More specifically, the particular size of a block depends on the codec and is usually a multiple of four pixels. The most frequently used block sizes are 4×4, 8×8, and 16×16 pixels. A block may also have a rectangular shape, with the height being 4, 8, 12, or 16 pixels and the width being 4, 8, 12, or 16 pixels, wherein the height is different from the width.

Color information may be encoded at a lower resolution than the luminance information. For example, the color information of an 8×8 block in a 4:1:1 color space is encoded using a YCbCr format, wherein the luminance (Y) is encoded in an 8×8 pixel format while the difference-red (Cr) and difference-blue (Cb) information is encoded in a 2×2 pixel format.

While this invention has been described with reference to illustrative embodiments, this description is not intended to be construed in a limiting sense.

Among other video processing applications, various embodiments of the invention can be used to implement a video transcoder, such as that disclosed in commonly owned U.S. patent application Ser. No. 13/163,853, filed on Jun. 20, 2011, which is incorporated herein by reference in its entirety.

Representative video encoders, using which various embodiments of the invention can be practiced, are disclosed, e.g., in U.S. Pat. Nos. 7,929,608, 7,688,893, 7,756,202, and 7,532,764, all of which are incorporated herein by reference in their entirety.

The flow of methods 300 and 2400 lends them to relatively straightforward parallelization that can be based on known branch-prediction techniques.

Various modifications of the described embodiments, as well as other embodiments of the invention, which are apparent to persons skilled in the art to which the invention pertains are deemed to lie within the principle and scope of the invention as expressed in the following claims.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements (such as the steps) in the following method claims are recited in a particular sequence with corresponding labeling (e.g., (a), (b), (c), etc.), unless the claim recitations otherwise imply a particular sequence for implementing some or all of those elements, those elements are not necessarily intended to be limited to being implemented in that particular sequence. The labeling has been inserted into the claims solely for the purpose of conveniently referring, in a dependent claim, to some of the elements recited in a corresponding base claim.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The present inventions may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

A person of ordinary skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. A machine-implemented method for encoding a block of video data based on a set of intra modes, the method comprising:
(a) generating an evaluation value for the block using each of a first subset of one or more of the intra modes;
(b) identifying in the first subset an intra mode having a best evaluation value so far;
(c) generating an evaluation value for the block using a current intra mode that is selected from the set, wherein:
the current intra mode is not in the first subset; and
in addition to the first subset and the current intra mode, the set further comprises two or more remaining intra modes;
(d) comparing the evaluation value corresponding to the current intra mode with the best evaluation value so far;
(e) selecting a next intra mode based on said comparison, wherein:
one of the two or more remaining intra modes is selected to be the next intra mode, if the evaluation value for the current intra mode is better than the best evaluation value so far; and
a different one of the two or more remaining intra modes is selected to be the next intra mode, if the evaluation value for the current intra mode is not better than the best evaluation value so far; and
(f) generating an evaluation value for the block using said next intra mode.

2. The method of claim 1, wherein step (e) further comprises updating the best evaluation value so far after including the current intra mode into the first subset.

3. The method of claim 1, further comprising:
(g) determining whether the next intra mode satisfies a search-termination criterion;
(h) repeating steps (d)-(g) for the next intra mode if the next intra mode does not satisfy the search-termination criterion; and
(i) using the intra mode corresponding to the best evaluation value so far to encode the block if the next intra mode does satisfy the search-termination criterion, without evaluating any more of the remaining intra modes.

4. The method of claim 3, wherein the search-termination criterion is satisfied if a sum of absolute differences (SAD) corresponding to the current intra mode is smaller than a threshold value.

5. The method of claim 3, wherein the search-termination criterion is satisfied if a specified video-quality measure is smaller than a threshold value, said video-quality measure being based on:
a minimum SAD among the SADs of a set consisting of the current intra mode and the first subset; and
a maximum SAD among the SADs of the set consisting of the current intra mode and the first subset.

6. A machine-implemented video-encoding method, comprising:
while a search-termination criterion for a pixel block is not triggered, iteratively probing different intra modes by:
selecting, based on a set of mode-selection rules, a candidate intra mode from a basis set of intra modes;
comparing a value of an evaluation criterion corresponding to the selected intra mode with a best value of the evaluation criterion, said best value being determined over a set consisting of the intra modes that have been selected so far during said iterative probing; and
determining, based on said comparison, whether the selected intra mode represents a success or a failure, wherein the set of mode-selection rules comprises at least one rule that is conditioned on success or failure;
when the search-termination criterion is triggered, identifying an optimal intra mode within a set consisting of intra modes that have been selected while the search termination criterion was not yet triggered; and
encoding the pixel block using said optimal intra mode.

7. The method of claim 1, wherein:
the search-termination criterion is triggered when a specified video-quality measure is smaller than a threshold value; and
the method further comprises changing the threshold value while a video sequence is being encoded.

8. The method of claim 7, wherein a change of the threshold value is performed when processing power available in a host device for executing the method changes.

9. The method of claim 6, wherein the set of mode-selection rules comprises a set of rules that specify transitions between intra modes 0-1, 3-8.

10. The method of claim 9, wherein:
the set of mode-selection rules further comprises a pointer to intra mode 2; and
the pointer is invoked before the set of rules that specify transitions between intra modes 0-1, 3-8.

11. The method of claim 9, wherein the set of rules that specify transitions between intra modes 0-1, 3-8 prescribes intra mode 1 to be selected first among intra modes 0-1, 3-8.

12. The method of claim 9, wherein the set of rules that specify transitions between intra modes 0-1, 3-8 prescribes intra mode 0 to be selected first among intra modes 0-1, 3-8.

13. The method of claim 9, wherein the set of rules that specify transitions between intra modes 0-1, 3-8 causes a single intra mode to be selected per iteration.

14. The method of claim 9, wherein the set of rules that specify transitions between intra modes 0-1, 3-8 represents a decision tree whose degree of misbalance is 0, 1, or 2.

15. The method of claim 9, wherein the set of rules that specify transitions between intra modes 0-1, 3-8 causes at least one intra mode to be left out, without possible transitions to it.

16. The method of claim 9, wherein the set of rules that specify transitions between intra modes 0-1, 3-8 defines two or more transitions that share a common ending intra mode.

17. The method of claim 6, wherein the set of mode-selection rules causes:
a single intra mode to be selected per iteration;
intra mode 2 to be selected first;
intra mode 1 to be selected second; and
intra mode 0 to be selected third.

18. The method of claim 17, wherein intra mode 0 is selected third regardless of whether intra mode 1 represents a success or a failure.

19. The method of claim 6, wherein the set of mode-selection rules is implemented using a look-up table.

20. An apparatus, comprising a video-encoder configured to:
while a search-termination criterion for a pixel block is not triggered, iteratively probe different intra modes, wherein the video encoder
selects a candidate intra mode from a basis set of intra modes based on a set of mode-selection rules; and
compares a value of an evaluation criterion corresponding to the selected intra mode with a best value of the evaluation criterion, said best value being determined over a set consisting of the intra modes that have been selected so far during said iterative probing; and
determines, based on said comparison, whether the selected intra mode represents a success or a failure, wherein the set of mode-selection rules comprises at least one rule that is conditioned on success or failure;
when the search-termination criterion is triggered, identify an optimal intra mode within a set consisting of intra modes that have been selected and evaluated while the search termination criterion was not yet triggered; and
encode the pixel block using said optimal intra mode.
